(19) United States
(12) Patent Application Publication
(10) Pub. No.: US 2009/0016533 A1
(43) Pub. Date: Jan. 15, 2009

(54) Controlling With Rights Objects Delivery Of Broadcast Encryption Content For A Network Cluster From A Content Server Outside The Cluster

(75) Inventors: Eunjin Jung, Austin, TX (US); Amal Ahmed Shaheen, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/058,678

(22) Filed: Mar. 29, 2008

Related U.S. Application Data
(63) Continuation of application No. 10/926,599, filed on Aug. 26, 2004.

(51) Int. Cl. H04L 9/00; G06F 21/00

(52) U.S. Cl. 380/277; 726/31

(57) ABSTRACT

Methods, systems, and products are disclosed for controlling with rights objects delivery of broadcast encryption content for a network cluster from a content server outside the cluster that include receiving in the content server from a network device a key management block for the cluster, a unique data token for the cluster, and an encrypted cluster id; calculating a binding key for the cluster in dependence upon the key management block for the cluster, the unique data token for the cluster, and the encrypted cluster id; inserting a title key into a rights object defining rights for the broadcast encryption content; and sending the rights object to the cluster. In typical embodiments, the rights for content include an authorization for a play period and an authorized number of copies of the broadcast encryption content to devices outside the cluster.

### CROSS-REFERENCE TO RELATED APPLICATION

This application is a continuation application of and claims priority from U.S. patent application Ser. No. 10/926,599, filed on Aug. 26, 2004.

### BACKGROUND OF THE INVENTION

1. Field of the Invention

The field of the invention is data processing, or, more specifically, methods, systems, and products for controlling delivery of broadcast encryption content for a network cluster from a content server outside the cluster.

2. Description Of Related Art

With the advent of consumer digital technology, content such as music and movies are no longer bound to the physical media that carry it. Advances in consumer digital technology presents new challenges to content owners such as record labels, studios, distribution networks, and artists who want to protect their intellectual property from unauthorized reproduction and distribution. Recent advances in broadcast encryption offer an efficient alternative to more traditional solutions based on public key cryptography. In comparison with public key methods, broadcast encryption requires orders of magnitude less computational overhead in compliant devices. In addition, broadcast encryption protocols are one-way, not requiring any low-level handshakes, which tend to weaken the security of copy protection schemes. IBM has developed a content protection system based on broadcast encryption called eXtensible Content Protection, referred to as “xCP.” xCP supports a trusted domain called a ‘cluster’ that groups together a number of compliant devices. Content can freely move among these devices, but it is useless to devices that are outside the cluster. Each compliant device is manufactured with a set of device keys. A key management block (“KMB”) is a data structure containing an encryption of a management key using every compliant device key in the set of device keys for a compliant device. That is, a KMB contains a multiplicity of encrypted instances of a management key, one for every device key in the set of device keys for a device. Each compliant device, using one of its own device keys, is capable of extracting an encrypted management key from a key management block and decrypting it. That is, the management key for a cluster is calculated from the key management block, and it is the ability to calculate a management key from a key management block that distinguishes compliant devices.

A cluster is a private domain. Compliant devices can join a cluster. Some compliant devices in a cluster have specialized functions. Most devices do not store key management blocks; they read key management blocks from the cluster. A ‘kmbserver,’ however, is a device that stores the key management block and can update it. ‘Authorizers’ are network devices that can authorize other devices to join a cluster. In a compliant cluster, when a consumer purchases a device and installs it in his home, the device automatically determines which cluster is currently present, identifies an authorizer, and asks to join the cluster. In this specification, a network device that supports both an authorizer and an kmbserver is called a ‘cluster server.’

Each piece of content or each content stream in the home is protected with a unique key. These keys are called title keys. Each title key is encrypted with a master key for the particular home, called a binding key. To play protected content, a device reads the encrypted title key embedded in the content file and decrypts it with the binding key. Then, with the title key, the device decrypts the content itself. The binding key is calculated as the cryptographic hash of three quantities: the management key, the cluster ID, and a hash of the cluster's authorization table. The cluster ID is a unique identification code for a cluster established at cluster startup. The network authorization table is a simple file whose records represent the list of devices in the cluster.

Content providers need a binding key for a cluster to encrypt title keys to provide content encrypted so that it can only be decrypted by devices in the cluster. One way to get a cluster's binding key to a content server is for the content server to join the cluster. A content server, acting as a compliant device, may join a cluster as follows:
The content server broadcasts a “whosthere” message to a cluster network.
A cluster server answers with an “imhere” message, including cluster name, cluster server deviceID, cluster server device type, the cluster KMB, and a hash of a cluster authorization table.
The content server downloads the KMB from the cluster server.
The content server computes the cluster management key from the KMB and its own device keys.
The content server computes a message authorization code (“MAC”) by cryptographically hashing the management key with the content server's deviceID and the content server's device type code.
The content server sends an authorization request to the cluster server, including the content server's deviceID and device type.
The cluster server computes the management key using the KMB and its own device keys. This management key is the same as the management key computed by the content server.
The cluster server computes the MAC using the content server's deviceID and device type, verifying the MAC received from the content server.
If the MAC matches, the cluster server adds the content server to its authorization table.
The cluster server sends an ‘authorized’ message to the content server, including an encrypted clusterID, encrypted with a content server key created by hashing the management key and the content server's deviceID.
The content server generates the content server key by hashing the management key and the content server's deviceID and uses the content server key to decrypt the encrypted clusterID.
The content server downloads the new authorization table from the cluster server.
The content server computes the binding key for the cluster by hashing the management key, a hash of the new authorization table, and the clusterID.

There are some drawbacks to this procedure. The content server broadcasts messages to clusters, which is not an appropriate procedure for a content server to perform. In addition, this procedure adds the content server as a device in the cluster, counting as a device against any maximum device count and changing the authorization table for the cluster. Moreover, the procedure is lengthy. There is an ongoing need for improvement therefore in procedures for controlling broadcast encryption of content for a network cluster from a content server outside the cluster.

### SUMMARY OF THE INVENTION

Methods, systems, and products are disclosed for controlling with rights objects delivery of broadcast encryption content for a network cluster from a content server outside the cluster that include receiving in the content server from a network device a key management block for the cluster, a unique data token for the cluster, and an encrypted cluster id; calculating a binding key for the cluster in dependence upon the key management block for the cluster, the unique data token for the cluster, and the encrypted cluster id; inserting a title key into a rights object defining rights for the broadcast encryption content; and sending the rights object to the cluster. In typical embodiments, calculating a binding key includes calculating a management key from the key management block for the cluster, calculating a content server device key from the management key and the content server device id, decrypting the encrypted cluster id with the content server device key, and calculating the binding key with the management key, the unique data token for the cluster, and the cluster id. In typical embodiments, the rights for content include an authorization for a play period and an authorized number of copies of the broadcast encryption content to devices outside the cluster.

Many embodiments include encrypting the content for the cluster with the title key, encrypting the rights object with the binding key, and packaging the encrypted rights object with the encrypted content for the cluster, where sending the rights object to the cluster includes sending the rights object encrypted and packaged with the encrypted content. Many embodiments include encrypting the rights object with the binding key and storing the rights object on a digital rights server, where sending the rights object to the cluster is carried out by sending the encrypted rights object from the digital rights server separately from the broadcast encryption content. Many embodiments also include encrypting the title key with the binding key and storing the rights object on a digital rights server, where inserting a title key into a rights object includes inserting the encrypted title key into the rights object and sending the rights object to the cluster is carried out by sending the rights object from the digital rights server separately from the broadcast encryption content. In typical embodiments, the broadcast encryption content includes a content identifier and a location of a digital rights server where the rights object is stored. Many embodiments include relating the rights object to the broadcast encryption content through a content identifier and a cluster identifier. Many embodiments include relating the rights object to the broadcast encryption content through a content identifier and a device identifier. The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a line drawing of an exemplary network architecture in which methods and systems according to embodiments of the present invention may be implemented.

FIG. 1A sets forth a block diagram of an exemplary system for controlling delivery of broadcast encryption content.

FIG. 1B sets forth a block diagram of another exemplary system for controlling delivery of broadcast encryption content according to embodiments of the present invention.

FIG. 2 sets forth a data flow diagram illustrating an exemplary method for controlling delivery of broadcast encryption content for a network cluster from a content server outside the cluster.

FIG. 2A sets forth a data flow diagram illustrating an exemplary method for sending a rights object to a cluster.

FIG. 3 sets forth a data flow diagram illustrating an exemplary method of calculating a binding key.

FIG. 4 sets forth a data flow diagram illustrating an exemplary method for encrypting a cluster id in a network device.

FIG. 5 sets forth a flow chart illustrating an exemplary method for delivering broadcast encryption content.

### DETAILED DESCRIPTION OF EXEMPLARY EMBODIMENTS

### Introduction

The present invention is described to a large extent in this specification in terms of methods for controlling delivery of broadcast encryption content for a network cluster from a content server outside the cluster. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Controlling With Rights Objects Delivery of Broadcast Encryption Content For A Network Cluster From A Content Server Outside The Cluster

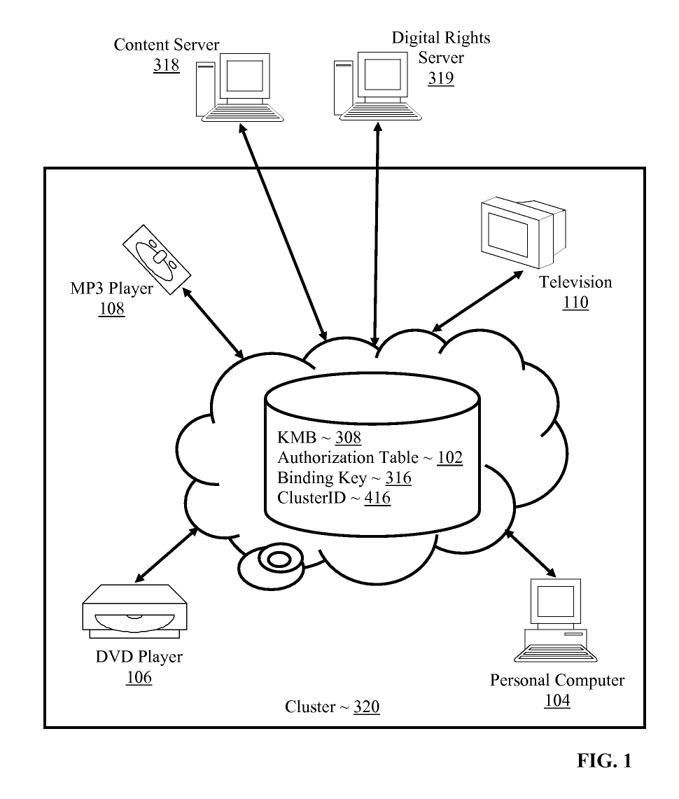

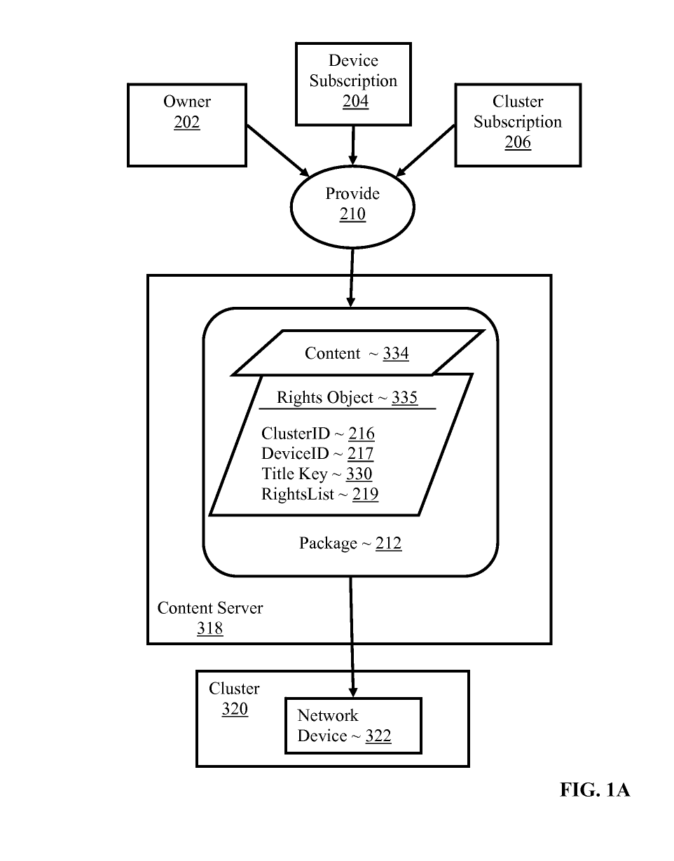

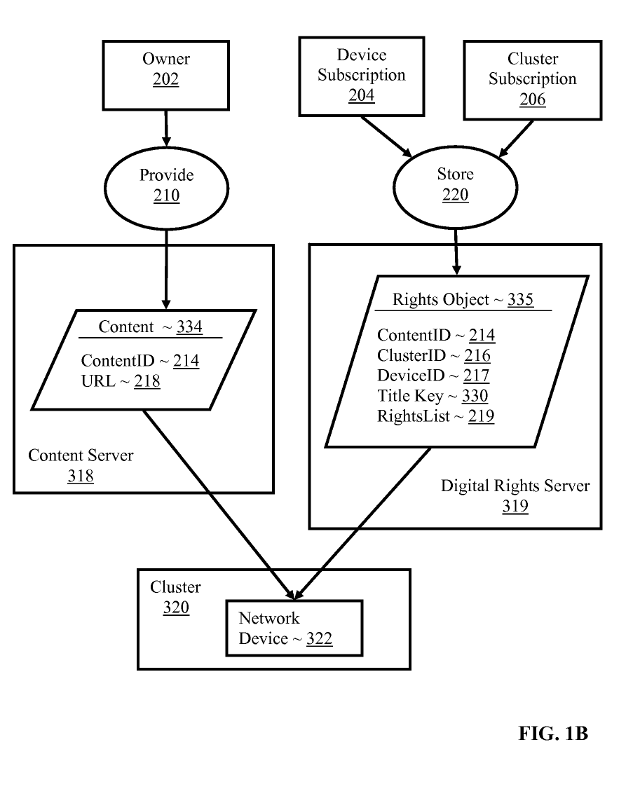

Methods, systems, and products are disclosed for controlling delivery of broadcast encryption content for a network cluster from a content server outside the cluster that operate generally by providing the content server with enough information for it to package content for a specific cluster. FIG. 1 sets forth a line drawing of an exemplary network architecture in which methods and systems according to embodiments of the present invention may be implemented. The network of FIG. 1 includes an xCP compliant network cluster (320) that includes several xCP compliant network devices including an MP3 player (108), a television (110), a DVD player (106), and a personal computer (104).

The network cluster supports a key management block (308) for the cluster, an authorization table (102) that identifies all the devices currently authorized to join the cluster, a binding key (316) for the cluster, and a cluster ID (416). The key management block (308) is a data structure containing an encryption of a management key with every compliant device key. That is, the key management block contains a multiplicity of encrypted instances of a management key, one for every device key in the set of device keys for a device. The binding key (316) for the cluster is calculated as a cryptographic hash of a management key, a cluster ID, and a unique data token for the cluster. The management key for the cluster is calculated from the key management block (308) and device keys.

The network of FIG. 1 includes a content server (318) that is capable of encrypting content with title keys provided to it by content providers, content owners, or a legal licensing authority. Content server (318) is also capable of calculating a binding key for a cluster, given enough information about the cluster, and using the binding key to encrypt a title key and package it with encrypted contents. More particularly, content server (318) may control broadcast encryption of content for a network cluster (320) from outside the cluster by receiving from a network device in the cluster a key management block (308) for the cluster (320), a unique data token for the cluster (320), and an encrypted cluster id. The content server is capable of using the key management block (308) for the cluster (320), the unique data token for the cluster (320), and the encrypted cluster id to calculate the binding key for the cluster.

The network of FIG. 1 includes a digital rights server (319) that is capable of storing rights objects that define rights for the broadcast encryption content. In addition, a digital rights server (319) is also capable of calculating a binding key for a cluster, given enough information about the cluster, and using the binding key to encrypt a title key and insert it into a rights object. More particularly, digital rights server (319) may function to control broadcast encryption of content for a network cluster (320) from outside the cluster by encrypting a title key with a binding key (316), inserting the encrypted title key into the rights object, and sending the rights object separately from broadcast encryption content. A digital rights server may be capable of using a key management block (308) for the cluster (320), a unique data token for the cluster (320), and an encrypted cluster id to calculate a binding key for the cluster.

For further explanation, FIG. 1A sets forth a block diagram of a system for controlling delivery of broadcast encryption content where broadcast encryption content (334) and an associated rights object defining digital rights for the broadcast encryption content are included within a package (212) for sending from a content server (318) to a network device (322) in a cluster (320). In the example of FIG. 1A, an owner (202), that is, a content provider, a content owner, or a legal licensing authority, provides (210) content (334) and a rights list (219) for the content for inclusion in a package for a cluster. The owner provides the rights list according to subscription rights for a device (204) or a cluster (206). From the point of view of the cluster or a network device in the cluster, according to embodiments of the present invention, it makes no difference whether the rights list was for a device or a cluster, because the cluster is fashioned according to embodiments of the present invention to administer a device identifier in a rights object as though it were a cluster identifier.

For further explanation, FIG. 1B sets forth a block diagram of a system for controlling delivery of broadcast encryption content according to embodiments of the present invention that operates generally by encrypting a rights object (335) with a binding key and storing (220) the rights object on a digital rights server (319) separately from corresponding broadcast encryption content (334) stored on a content server (318). In such a system, sending a rights object (335) to a cluster (320) may be carried out by sending an encrypted rights object from the digital rights server separately from the broadcast encryption content. As discussed below, some systems for controlling delivery of broadcast encryption content according to embodiments of the present invention alternatively send rights objects to clusters by sending an unencrypted rights object containing an encrypted title key.

In the example of FIG. 1B, an owner (202), that is, a content provider, a content owner, or a legal licensing authority, provides (210) broadcast encryption content (334) stored on a content server (318) and stores (220) a rights list (219) for associated broadcast encryption content on a digital rights server. The owner provides the rights list according to subscription rights for a non-cluster device (204) or for a cluster (206). From the point of view of the cluster or a network device in the cluster, according to embodiments of the present invention, it makes no difference whether the rights list was for a device or a cluster, because the cluster is fashioned according to embodiments of the present invention to administer a device identifier in a rights object as though it were a cluster identifier.

In the example of FIG. 1B, the broadcast encryption content (334) includes a content identifier (214) and a location (218) of a digital rights server where a corresponding rights object is stored. The content identifier (214) provides a foreign key to associate the broadcast encryption content (334) with a particular rights object on a digital rights server. The location (218) of a digital rights server where a corresponding rights object is stored in this example is implemented as a Universal Resource Locator, a ‘URL.’ A URL includes a network address of the digital rights server in question which may be implemented as a numeric address or as a domain name that resolves to a particular network address. In addition, the URL may contain a pathname or URL-encoded query data that specifies the exact location, selection criteria, or server-side functionality such as a Common Gateway Interface (‘CGI’) script or Java™ servlet for a particular rights object on a digital rights server. Although this example shows the location of the digital rights server indicated through a URL, in fact, that is not a limitation of the invention. The location of the digital rights server may be indicated by any useful structure or data encoding, including, for example, a plain network address, a pathname on the content server itself, a Universal Resource Identifier (‘URI’), or otherwise as will occur to those of skill in the art.

The rights object (335) includes a content identifier (214) that associates the rights object with its corresponding broadcast encryption content (334, 214). The rights object also includes a cluster identifier (216) and a device identifier (217). According to the example of FIG. 1B, a rights object for a cluster may be related to the broadcast encryption content through a content identifier and a cluster identifier. Alternatively in the example of FIG. 1B, a rights object for a cluster may be related to the broadcast encryption content through a content identifier and a device identifier. These alternatives are illustrated together in the example of FIG. 1B for ease of explanation - by the inclusion of both a cluster identifier and a device identifier. As a practical matter, in systems for controlling the delivery of broadcast encryption content according to embodiments of the present invention, only one identifier, a cluster identifier or a device identifier, is implemented in a typical rights object. In a device-oriented digital rights server, the identifier is a device identifier that may be interpreted in a cluster as a cluster identifier. In such systems, the fact that a cluster or a cluster network device interprets a device identifier from a device-oriented digital rights server as a cluster identifier may be entirely transparent to the digital rights server itself which may never know or care that the network device to which it delivers a rights object will use the rights object and its corresponding broadcast digital content across multiple network devices in a cluster rather than a single non-clustered device.

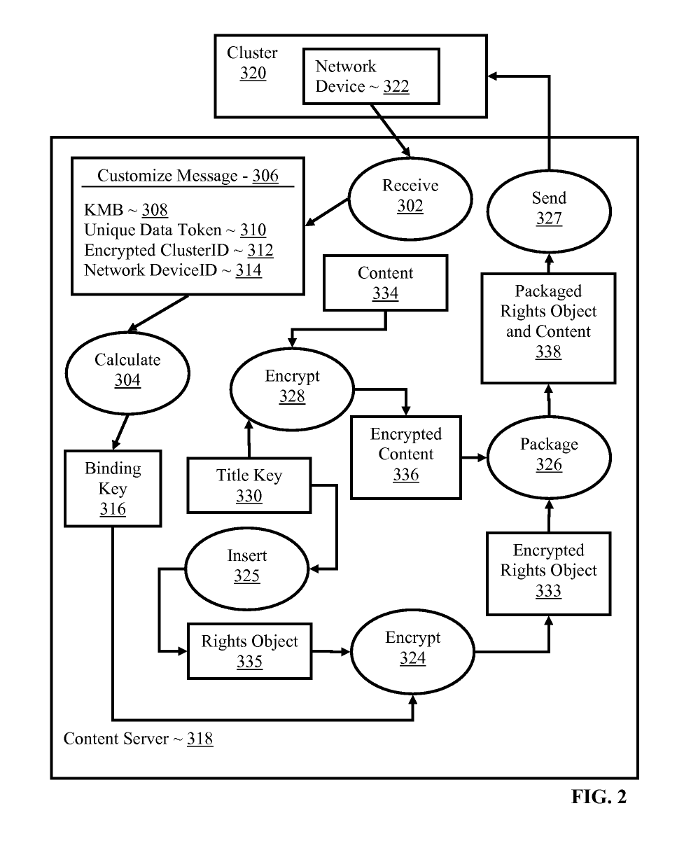

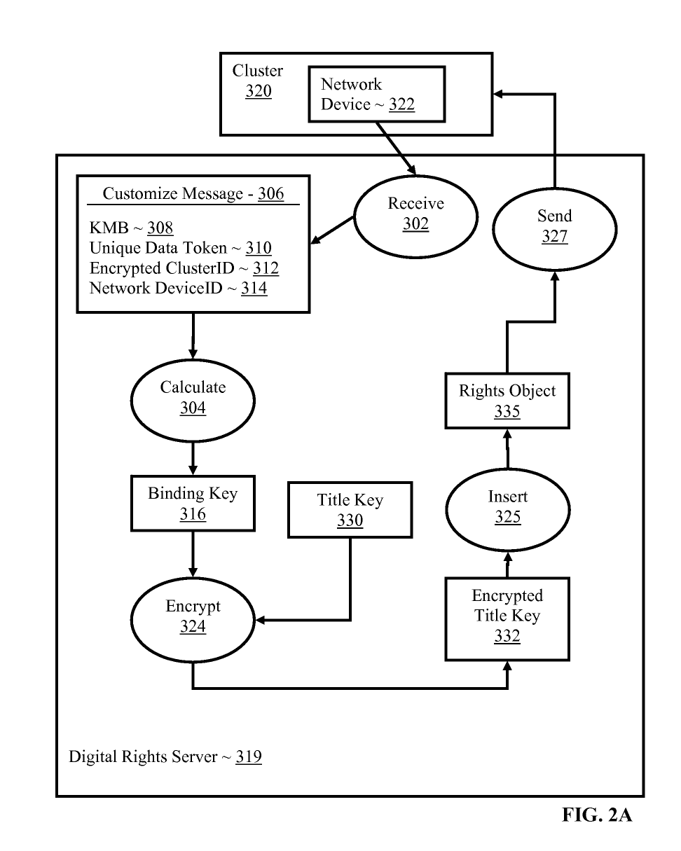

For further explanation, FIG. 2 sets forth a data flow diagram illustrating an exemplary method for controlling delivery of broadcast encryption content for a network cluster (320) from a content server (318) outside the cluster (320) that includes receiving (302) in the content server (318) from the network device (322) a key management block (308) for the cluster (320), a unique data token (310) for the cluster (320), and an encrypted cluster id (312). The unique data token (310) typically is produced by the network device (322) as a data value to be unique to the cluster at the time when it is received (302) in the content server (318). Examples of unique data tokens include a random number generated in the network device, a hash of an authorization table for the cluster, and others as will occur to those of skill in the art.

The method of FIG. 2 also includes calculating (304) a binding key (316) for the cluster (320) in dependence upon the key management block (308) for the cluster (320), the unique data token (310) for the cluster (320), and the encrypted cluster id (312). The method of FIG. 2 also includes inserting (325) a title key (330) into a rights object (335) defining rights for the broadcast encryption content (334). In the method of FIG. 2, the rights for content include an authorization for a play period and an authorized number of copies of the broadcast encryption content to devices outside the cluster.

The method of FIG. 2 also includes encrypting (328) the content (334) for the cluster with a title key (330), encrypting (324) the rights object (335) with the binding key (316); and packaging (326) the encrypted rights object (333)with the encrypted content (336) for the cluster (320). In the example of FIG. 2, the message structure (306) for the key management block (308), the unique data token (310), and the encrypted cluster id (312) is referred to as a ‘customize message’ because the effect of encrypting the content for the cluster with a title key, encrypting the rights object with the binding key, and packaging the encrypted rights object with the encrypted content for the cluster is to create content that is ‘customized’ in that only devices in that cluster can decrypt it.

The method of FIG. 2 also includes sending (327) the rights object (335) to the cluster (320). In the method of FIG. 2, sending (327) the rights object (335) to the cluster (320) further comprises sending the rights object (338) encrypted and packaged (338) with the encrypted content (336).

Encrypting the content for the cluster with a title key, encrypting the rights object with the binding key, and packaging the encrypted rights object with the encrypted content for the cluster prepares content for distribution to a requesting network device in a cluster. This procedure involves no authentication of a requesting device by the content server because the process produces content encrypted with a rights object having an inserted title key where the rights object is encrypted with a binding key so that the title key can only be retrieved by decrypting the rights object in a network device in a cluster using that exact binding key. The content server may freely offer the content to any device that requests it. Only devices in a cluster having the proper binding key can decrypt the content.

The content server may calculate the binding key for a cluster, encrypt content for the cluster, and download the content all as part of a single overall transaction, for example, on a pay per view or pay per file type of transaction, where the content server does not retain the binding key beyond the duration of the single transaction. Alternatively, the content server may provide a subscription service, for example, in which it advantageously retains a cluster's binding key for a longer period of time. In such a case, the content server advantageously associates with the binding key in computer memory an identifier for the cluster, such as, for example, a requesting device ID or a base URL for the requesting device communicated to the content server as part of an initial handshake, for example.

For further explanation, FIG. 2A sets forth a data flow diagram illustrating an exemplary method for sending a rights object to a cluster. The method of FIG. 2A may advantageously operate as part of a method of controlling delivery of broadcast encryption content for a network cluster from a content server outside the cluster as described above. The method of FIG. 2A includes receiving (302) in a digital rights server (319) from the network device (322) a key management block (308) for the cluster (320), a unique data token (310) for the cluster (320), and an encrypted cluster id (312). The unique data token (310) typically is produced by the network device (322) as a data value to be unique to the cluster at the time when it is received (302) in the digital rights server (319). Examples of unique data tokens include a random number generated in the network device, a hash of an authorization table for the cluster, and others as will occur to those of skill in the art.

The method of FIG. 2A also includes calculating (304) a binding key (316) for the cluster (320) in dependence upon the key management block (308) for the cluster (320), the unique data token (310) for the cluster (320), and the encrypted cluster id (312). The method of FIG. 2A also includes encrypting (324) the title key (330) with the binding key (316) and inserting (325) the encrypted title key (332) into a rights object (335). As described above, the rights object (335) may be stored in a contents server in association with broadcast encryption content. In this example, however, the rights object (335) is stored on a separate digital rights server (319) and associated with broadcast encryption content through a content identifier (214 on FIG. 1B). The method of FIG. 2A also includes sending (327) the rights object (335) from the digital rights server (319) separately from its associated broadcast encryption content—which is sent separately from a content server as described above.

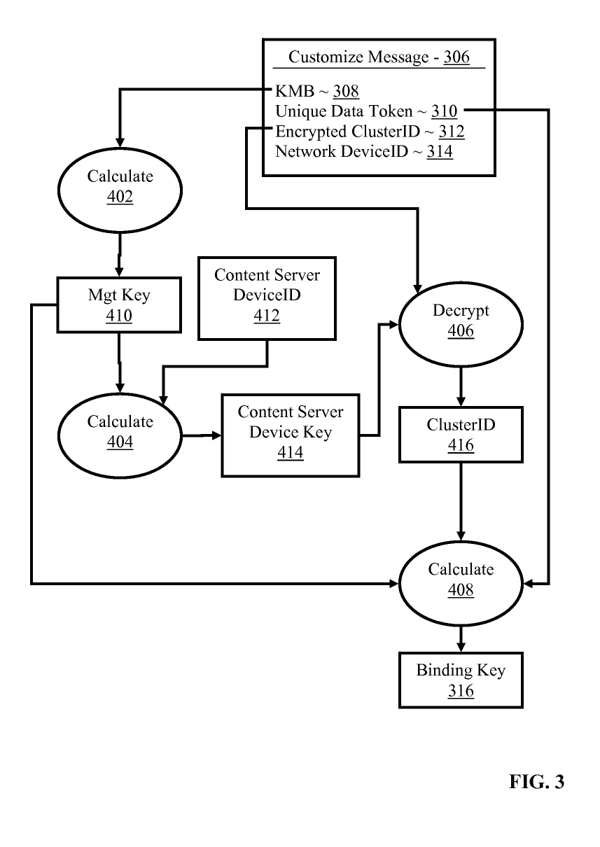

It is useful to note that the method of FIG. 2 includes calculating a binding key in a content server and the method of FIG. 2A includes calculating a binding key on a digital rights server. Because binding keys are typically calculated on the basis of shared secret data such as device identifiers and key management blocks and therefore not usually communicated as such across networks, it is also usual for binding keys to be calculated in cluster network devices. For further explanation, FIG. 3 sets forth a data flow diagram illustrating an exemplary method, useful in various locations in systems for controlling delivery of broadcast encryption content according to embodiments of the present invention, for calculating (304) a binding key (316) that includes calculating (402) a management key (410) from the key management block (308) for the cluster. A key management block may be implemented, for example, as a matrix of encrypted management keys, that is, a matrix made of the encryption of the management key using each different device key. A network device, in this example, content server (318), that knows a position in the matrix that was encrypted with its device key can calculate a management key by decrypting the value found at that position. The result is the management key.

The method of FIG. 3 also includes calculating (404) a content server device key (414) from the management key (410) and the content server device id (412). In the method of FIG. 3, calculating (404) a content server device key (414) may be carried out by hashing, with a one way cryptographic hash algorithm, the management key (410) and the content server device id (412). The method of FIG. 3 also includes decrypting (406) the encrypted cluster id (312) with the content server device key (414).

The method of FIG. 3 also includes calculating (408) the binding key (316) with the management key (410), the unique data token (310) for the cluster, and the cluster id (416). In the method of FIG. 3, calculating (408) the binding key (316) with the management key (410), the unique data token (310) for the cluster, and the cluster id (416) may be carried out by hashing, with a one way cryptographic hashing algorithm, the management key (410), the unique data token (310) for the cluster, and the cluster id (416).

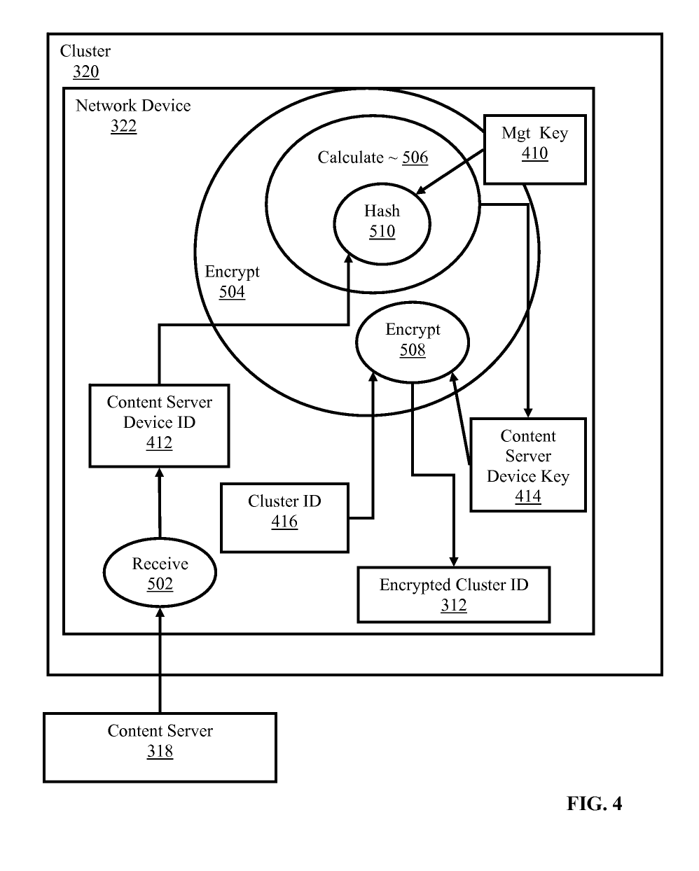

For further explanation, FIG. 4 sets forth a data flow diagram illustrating an exemplary method for encrypting (504) in the network device (322) a cluster id (416) in dependence upon a content server device id (412) for the content server (318). The method of FIG. 4 includes receiving (502) in the network device (322) a content server device id (412) from a content server (318). Alternatively, the network device receives the content server device ID (412) by retrieving the content server device ID from a content server device ID table, a network location, an on-line directory, or from any other source as will occur to those of skill in the art.

In the method of FIG. 4, encrypting (504) a cluster ID (416) includes calculating (506) a content server device key (414) and encrypting (508) the cluster id (416) with the content server device key (414). In the method of FIG. 4, calculating (506) a content server device key (414) may be carried out by hashing (510), with a one way cryptographic hash algorithm, the management key (410) and the content server device id (412).

For further explanation, a use case is presented that illustrates a content server calculating a binding key for a cluster where the content server's device ID is provided to a network device in the cluster as part of an initial handshake:
A cluster network device sends a request for a binding server to prepare content for use in the device's cluster.
The content server sends its content server device ID to a network device in a cluster.
The network device calculates a content server key as a hash of the management key for the cluster and the content server device ID.
The network device uses the content server key to encrypt its cluster ID.
The network device produces a unique data token for its cluster.
The network device sends to the content server the key management block for the cluster, the network device ID, the unique data token for the cluster, and the encrypted cluster ID.
The content server encrypts content for the cluster with a title key.
The content server computes the management key from the key management block using its own device key.
The content server computes the content server key as a hash of the management key and the content server device ID.
The content server decrypts the cluster ID with the content server key.
The content server creates a binding key as a hash of the management key, the unique data token for the cluster, and the now decrypted cluster ID.
The content server inserts the title key into a rights object that also contains a rights list defining digital rights for the associated broadcast encryption content.
The content server encrypts the rights object with the binding key.
The content server packages the encrypted rights object with the associated broadcast encryption content.
The content server sends the packaged encrypted content and encrypted rights object to the cluster network device.

Beginning with a request from a network device, this procedure involves no broadcast from the content server. The initial request is decoupled from any download of content which may occur as part of the same overall transaction with the request for preparation of content or may occur later or over a period of time. In this procedure, the content server does not join the cluster and the content server's operations therefore have no effect on the cluster's authorization table.

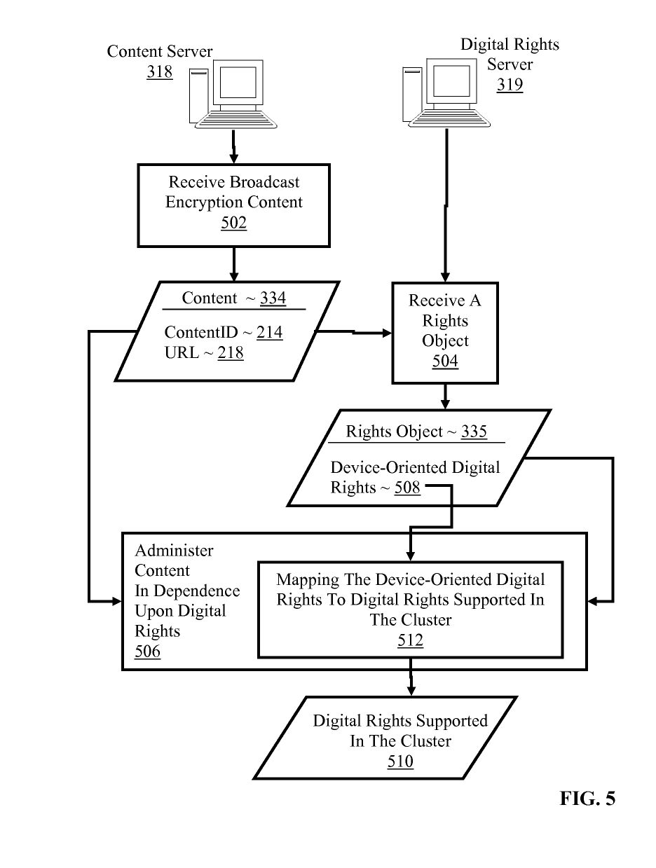

In addition, the digital rights set forth in the rights list in this exemplary use case may have been created to govern only non-cluster, device-oriented digital rights management, although they now may be used in the cluster for controlling delivery of broadcast encryption content according to embodiments of the present invention. In such systems, methods of operation usefully include methods for mapping device-oriented (non-cluster) digital rights to rights supported in a cluster. For further explanation, FIG. 5 sets forth a flow chart illustrating an exemplary method for delivering broadcast encryption content that includes receiving (502) in a cluster broadcast encryption content (334). The method of FIG. 5 also includes receiving (504) in a cluster a rights object (335) defining device-oriented digital rights (508) for broadcast encryption content (334).

Examples of device-oriented rights for encryption content include an authorization to move the content to a device outside the cluster, a play count for the broadcast encryption content, an exclusion of cluster play for the broadcast encryption content, digital rights for a device type, or any other device-oriented rights for encryption content that will occur to those of skill in the art. An authorization to move the content to a device outside the cluster is an authorization to move broadcast encryption content to a device that is not presently authorized to operate within the cluster. In this context, ‘move’ means to copy the broadcast encryption content to a non-cluster device and then delete the broadcast encryption content from the storage within the cluster—that is, from storage on any device that is authorized within the cluster.

A play count for the broadcast encryption content is a specified maximum number of plays for broadcast encryption content on any cluster network device. Administration of a play count requires stateful maintenance of a count of the number of times the broadcast encryption content has been played.

An exclusion of cluster play for the broadcast encryption content is a method for respecting the possibility that an owner may intend certain broadcast encryption content for non-cluster play on individual non-cluster devices only. That is, in compliant clusters, a serving cluster device that downloads from a digital rights server a rights object having its ‘no cluster play’ flag set to TRUE, simply discards the associated broadcast encryption content and the associated rights object. This is a useful feature because the digital rights server may have, and indeed often will have, no idea whatsoever that the receiving entity is a cluster rather than an individual subscribing device. The ‘no cluster play’ flag therefore is an opportunity for an owner to place broadcast encryption content and associated rights objects on servers and make them available only to individual non-cluster device with no need to worry that compliant clusters devices will play such content.

Digital rights for a device type are data identifying certain rights in a rights list for certain types of devices. Digital rights for a device type advantageously allows an owner to designate specific digital rights for specific types of devices. Such digital rights for a device type advantageously provide content owners with an increased ability to control the manner in which the broadcast encryption content is played, copied, or otherwise administered.

The method of FIG. 5 also includes administering (506) the broadcast encryption content (334) on one or more network devices in the cluster in dependence upon the digital rights (508). Administering (506) the broadcast encryption content (334) on one or more network devices in the cluster in dependence upon the digital rights (508) may include playing the broadcast encryption content on one or more network devices in accordance with the digital rights included in the rights list of a rights object associated with the broadcast encryption content. Administering (506) the broadcast encryption content (334) on one or more network devices in the cluster in dependence upon the digital rights (508) may also include copying the broadcast encryption content to one or more non-cluster network devices or moving the broadcast encryption content from one or more non-cluster network devices to another network device in accordance with the digital rights included in the rights list of a rights object associated with the broadcast encryption content.

In the method of FIG. 5, administering (506) the broadcast encryption content (334) on one or more network devices in the cluster in dependence upon the digital rights (508) is carried out by mapping (512) the device-oriented digital rights (508) to digital rights (510) supported in the cluster, excluding device-oriented rights not supported in the cluster. Consider an example in which a cluster supports a play period and the device-oriented rights support both a play period and a maximum play count. In mapping the device-oriented rights to the cluster rights in this example only the play period is supported in the cluster and the maximum play count is excluded.

In the method of FIG. 5, mapping (512) the device-oriented digital rights (508) to digital rights (510) supported in the cluster may be carried out for example by supporting in the cluster only those device-oriented digital rights having direct analogs in the cluster. More particularly, consider an example in which the cluster supports a play period and a right list intended for non-cluster oriented devices also supports a play period. In this example, the non-cluster rights map directly to the cluster rights.

In the method of FIG. 5, mapping (512) the device-oriented digital rights (508) to digital rights (510) supported in the cluster may also be carried out by mapping according to a ruleset one or more device-oriented digital rights having no direct analogs in the cluster. Consider an example in which the cluster supports a play period, the non-cluster device-oriented digital rights supports a maximum play count, and a ruleset includes a rule that maps play counts to play period at the rate of one play per week. If the maximum count in this example were 25, then the device oriented maximum play count of 25 maps to a cluster play period of 25 weeks.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1 A method for controlling with rights objects the delivery of broadcast encryption content for a network cluster from a content server outside the cluster, the method comprising:
receiving in the content server from a network device a key management block for the cluster, a unique data token for the cluster, and an encrypted cluster id;
calculating a binding key for the cluster in dependence upon the key management block for the cluster, the unique data token for the cluster, and the encrypted cluster id;
inserting a title key into a rights object defining rights for the broadcast encryption content; and
sending the rights object to the cluster.

2. The method of claim 1 wherein the rights for content include an authorization for a play period and an authorized number of copies of the broadcast encryption content to devices outside the cluster.

3. The method of claim 1 further comprising:
encrypting the content for the cluster with the title key;
encrypting the rights object with the binding key; and
packaging the encrypted rights object with the encrypted content for the cluster;
wherein sending the rights object to the cluster further comprises sending the rights object encrypted and packaged with the encrypted content.

4. The method of claim 1 further comprising:
encrypting the rights object with the binding key; and
storing the rights object on a digital rights server;
wherein sending the rights object to the cluster further comprises sending the encrypted rights object from the digital rights server separately from the broadcast encryption content.

5. The method of claim 1 further comprising:
encrypting the title key with the binding key; and
storing the rights object on a digital rights server;
wherein:
inserting a title key into a rights object further comprises inserting the encrypted title key into the rights object; and
sending the rights object to the cluster further comprises sending the rights object from the digital rights server separately from the broadcast encryption content.

6. The method of claim 1 wherein the broadcast encryption content further comprises a content identifier and a location of a digital rights server where the rights object is stored.

7. The method of claim 1 further comprising relating the rights object to the broadcast encryption content through a content identifier and a cluster identifier.

8. The method of claim 1 further comprising relating the rights object to the broadcast encryption content through a content identifier and a device identifier.

9. The method of claim 1 wherein calculating a binding key further comprises:
calculating a management key from the key management block for the cluster;
calculating a content server device key from the management key and the content server device id;
decrypting the encrypted cluster id with the content server device key; and
calculating the binding key with the management key, the unique data token for the cluster, and the cluster id.

10. A system for controlling with rights objects the delivery of broadcast encryption content for a network cluster from a content server outside the cluster, the system comprising:
means for receiving in the content server from a network device a key management block for the cluster, a unique data token for the cluster, and an encrypted cluster id;
means for calculating a binding key for the cluster in dependence upon the key management block for the cluster, the unique data token for the cluster, and the encrypted cluster id;
means for inserting a title key into a rights object defining rights for the broadcast encryption content; and
means for sending the rights object to the cluster.

11. The system of claim 10 wherein the rights for content include an authorization for a play period and an authorized number of copies of the broadcast encryption content to devices outside the cluster.

12. The system of claim 10 further comprising:
means for encrypting the content for the cluster with the title key;
means for encrypting the rights object with the binding key; and
means for packaging the encrypted rights object with the encrypted content for the cluster;
wherein means for sending the rights object to the cluster further comprises means for sending the rights object encrypted and packaged with the encrypted content.

13. The system of claim 10 further comprising:
means for encrypting the rights object with the binding key; and
means for storing the rights object on a digital rights server;
wherein means for sending the rights object to the cluster further comprises means for sending the encrypted rights object from the digital rights server separately from the broadcast encryption content.

14. The system of claim 10 further comprising:
means for encrypting the title key with the binding key; and
means for storing the rights object on a digital rights server;
wherein:
means for inserting a title key into a rights object further comprises means for inserting the encrypted title key into the rights object; and
means for sending the rights object to the cluster further comprises means for sending the rights object from the digital rights server separately from the broadcast encryption content.

15. The system of claim 10 wherein the broadcast encryption content further comprises a content identifier and a location of a digital rights server where the rights object is stored.

16. The system of claim 10 further comprising means for relating the rights object to the broadcast encryption content through a content identifier and a cluster identifier.

17. The system of claim 10 further comprising means for relating the rights object to the broadcast encryption content through a content identifier and a device identifier.

18. The system of claim 10 wherein means for calculating a binding key further comprises:
means for calculating a management key from the key management block for the cluster;
means for calculating a content server device key from the management key and the content server device id;
means for decrypting the encrypted cluster id with the content server device key; and
means for calculating the binding key with the management key, the unique data token for the cluster, and the cluster id.

19. A computer program product for controlling with rights objects the delivery of broadcast encryption content for a network cluster from a content server outside the cluster, the computer program product comprising:
a recording medium;
means, recorded on the recording medium, for receiving in the content server from a network device a key management block for the cluster, a unique data token for the cluster, and an encrypted cluster id;
means, recorded on the recording medium, for calculating a binding key for the cluster in dependence upon the key management block for the cluster, the unique data token for the cluster, and the encrypted cluster id;
means, recorded on the recording medium, for inserting a title key into a rights object defining rights for the broadcast encryption content; and
means, recorded on the recording medium, for sending the rights object to the cluster.

20. The computer program product of claim 19 wherein the rights for content include an authorization for a play period and an authorized number of copies of the broadcast encryption content to devices outside the cluster.

21. The computer program product of claim 19 further comprising:
means, recorded on the recording medium, for encrypting the content for the cluster with the title key;
means, recorded on the recording medium, for encrypting the rights object with the binding key; and
means, recorded on the recording medium, for packaging the encrypted rights object with the encrypted content for the cluster;
wherein means, recorded on the recording medium, for sending the rights object to the cluster further comprises means, recorded on the recording medium, for sending the rights object encrypted and packaged with the encrypted content.

22. The computer program product of claim 19 further comprising:
means, recorded on the recording medium, for encrypting the rights object with the binding key; and
means, recorded on the recording medium, for storing the rights object on a digital rights server;
wherein means, recorded on the recording medium, for sending the rights object to the cluster further comprises means, recorded on the recording medium, for sending the encrypted rights object from the digital rights server separately from the broadcast encryption content.

23. The computer program product of claim 19 further comprising:
means, recorded on the recording medium, for encrypting the title key with the binding key; and
means, recorded on the recording medium, for storing the rights object on a digital rights server;
wherein:
means, recorded on the recording medium, for inserting a title key into a rights object further comprises means, recorded on the recording medium, for inserting the encrypted title key into the rights object; and
means, recorded on the recording medium, for sending the rights object to the cluster further comprises means, recorded on the recording medium, for sending the rights object from the digital rights server separately from the broadcast encryption content.

24. The computer program product of claim 19 wherein the broadcast encryption content further comprises a content identifier and a location of a digital rights server where the rights object is stored.

25. The computer program product of claim 19 further comprising means, recorded on the recording medium, for relating the rights object to the broadcast encryption content through a content identifier and a cluster identifier.

26. The computer program product of claim 19 further comprising means, recorded on the recording medium, for relating the rights object to the broadcast encryption content through a content identifier and a device identifier.

27. The computer program product of claim 19 wherein means, recorded on the recording medium, for calculating a binding key further comprises:
means, recorded on the recording medium, for calculating a management key from the key management block for the cluster;
means, recorded on the recording medium, for calculating a content server device key from the management key and the content server device id;
means, recorded on the recording medium, for decrypting the encrypted cluster id with the content server device key; and
means, recorded on the recording medium, for calculating the binding key with the management key, the unique data token for the cluster, and the cluster id.
